(19) United States
(12) Patent Application Publication
(10) Pub. No.: US 2002/0093115 A1
(43) Pub. Date: Jul. 18, 2002

(54) Layer manufacturing method and apparatus using a programmable planar light source

(76) Inventors: B. Z. Jang, Auburn, AL (US); Junhai Liu, Auburn, AL (US); Liangwei Wu, Auburn, AL (US)

Correspondence Address: B. Z. Jang, 2076 S. Evergreen Dr., Auburn, AL, 36830, US

(21) Appl. No.: 09/760,441

(22) Filed: Jan. 12, 2001

(51) Int. Cl. B29C 35/08

(52) U.S. Cl. 264/113; 425/73; 425/140; 425/162; 425/174.4; 264/401; 264/463; 264/494; 264/40.1

(57) ABSTRACT

A method and related apparatus for fabricating a three-dimensional object in accordance with a computer-aided design of the object in a layer-by-layer but not point-by-point fashion. The method includes the following steps: (a) providing a work surface lying substantially parallel to an X-Y plane of an X-Y-Z Cartesian coordinate; (b) feeding a first layer of a first powder to this work surface and spraying a photo-curable adhesive to this powder; (c) directing a programmable planar light source to predetermined areas of the first layer to at least partially cure the adhesive and bond the powder particles together in these areas for the purpose of forming the first cross-section of this object; (d) feeding a second layer of a second powder onto the first layer, spraying the photo-curable adhesive onto the second powder layer, and directing a programmable planar light source to predetermined areas of the second layer to at least partially cure the adhesive and bond the powder particles together in these areas for the purpose of forming the second cross-section of the object; (e) repeating the feeding, spraying and directing steps to build successive layers along the Z-direction in a layer-wise fashion in accordance with the design for forming multiple layers of the object; and (f) removing un-bonded powder particles and un-cured adhesive to reveal the 3-D object.

### FIELD OF THE INVENTION

This invention relates generally to a computer-controlled method and apparatus for fabricating a three-dimensional (3-D) object and, in particular, to an improved method and apparatus for building a 3-D object directly from a computer-aided design of the object in a layer-by-layer, but not point-by-point fashion. The presently invented method is referred to as a Full-Area Curing Technique (FACT).

### BACKGROUND OF THE INVENTION

Solid freeform fabrication (SFF) or layer manufacturing (LM) is a new fabrication technology that builds an object of any complex shape layer by layer or point by point without using a pre-shaped tool such as a die or mold. This process begins with creating a Computer Aided Design (CAD) file to represent the geometry or drawing of a desired object. As a common practice, this CAD file is converted to a stereo lithography (.STL) format in which the exterior and interior surfaces of the object is approximated by a large number of triangular facets that are connected in a vertex-to-vertex manner. A triangular facet is represented by three vertex points each having three coordinate points: (x₁,y₁,z₁), (x₂,y₂,z₂), and (x₃,y₃,z₃). A perpendicular unit vector (i,j,k) is also attached to each triangular facet to represent its normal for helping to differentiate between an exterior and an interior surface. This object image file is further sliced into a large number of thin layers with the contours of each layer being defined by a plurality of line segments connected to form polylines on an X-Y plane of a X-Y-Z orthogonal coordinate system. The layer data are converted to tool path data normally in terms of computer numerical control (CNC) codes such as G-codes and M-codes. These codes are then utilized to drive a fabrication tool for defining the desired areas of individual layers and stacking up the object layer by layer along the Z-direction.

The SFF technology enables direct translation of the CAD image data into a three-dimensional (3-D) object. The technology has enjoyed a broad array of applications such as verifying CAD database, evaluating engineering design feasibility, testing part functionality, assessing aesthetics, checking ergonomics of design, aiding in tool and fixture design, creating conceptual models and marketing tools, producing medical or dental models, generating patterns for investment casting, reducing or eliminating engineering changes in production, and providing small production runs.

The SFF techniques may be divided into three categories: layer-additive, layer-subtractive, and hybrid (combined layer-additive and subtractive). A layer additive process involves adding or depositing a material to form predetermined areas of a layer essentially point by point; but a multiplicity of points may be deposited at the same time in some techniques, such as of the multiple-nozzle inkjet-printing type. These predetermined areas together constitute a thin cross-section of a 3-D object as defined by a CAD geometry. Successive layers are then deposited in a predetermined sequence with a layer being affixed to its adjacent layers for forming an integral multi-layer object. A 3-D object, when sliced into a plurality of constituent layers or thin sections, may contain features that are not self-supporting and in need of a support structure during the object-building procedure. These features include isolated islands in a layer and overhangs. In these situations, additional steps of building the support structure, also on a layer-by-layer basis, will be required of a layer-additive technique. An example of a layer-additive technique that normally requires building a support structure is the fused deposition modeling (FDM) process as specified in U.S. Pat. No. 5,121,329; issued on Jun. 9,1992 to S. S. Crump.

A layer-subtractive process involves feeding a complete solid layer of a material to the surface of a support platform and using a cutting tool (normally a laser) to cut off or somehow degrade the integrity of the un-wanted areas of this solid layer. The solid material in these un-wanted areas of a layer becomes a part of the support structure for subsequent layers. These un-wanted areas are hereinafter referred to as the “negative region” while the remaining areas that constitute a cross-section of a 3-D object are referred to as the “positive region”. A second solid layer of material is then fed onto the first layer and bonded thereto. The same cutting tool is then used to cut off or degrade the material in the negative region of this second layer. These procedures are repeated successively until multiple layers are laminated to form a unitary object. After all layers have been completed, the unitary body (or part block) is removed from the platform, and the excess material (in the negative region) is removed to reveal the 3-D object. This “decubing” procedure is known to be tedious and difficult to accomplish without damaging the object. An example of a layer-subtractive technique is the well-known laminated object manufacturing (LOM), disclosed in, for instance, U.S. Pat. No. 4,752,352 (Jun. 21, 1988 to M. Feygin).

A hybrid process involves both layer-additive and subtractive procedures. An example can be found with the Shape Deposition Manufacturing (SDM) process disclosed in U.S. Pat. No. 5,301,863 issued on Apr. 12, 1994 to Prinz and Weiss. The SDM-based fabrication system contains a material deposition station and a plurality of processing stations (for mask making, heat treating, packaging, complementary material deposition, shot peening, cleaning, shaping, sand-blasting, and inspection). The combined deposition-shaping procedures qualify the SDM as a hybrid layer manufacturing technique. In the SDM system, each processing station performs a separate function such that when the functions are performed in series, a layer of an object is produced and is prepared for the deposition of the next layer. This system requires an article transfer apparatus, a robot arm, to repetitively move the object-supporting platform and any layers formed thereon out of the deposition station into one or more of the processing stations before returning to the deposition station for building the next layer. These additional operations in the processing stations tend to shift the relative position of the object with respect to the object platform. Further, the transfer apparatus may not precisely bring the object to its exact previous position. Hence, the subsequent layer may be deposited on an incorrect spot, thereby compromising part accuracy. The more processing stations that the growing object has to go through, the higher the chances are for the part accuracy to be lost. Such a complex and complicated process necessarily makes the over-all fabrication equipment bulky, heavy, expensive, and difficult to maintain. The equipment also requires attended operation.

Another good example of the layer-additive technique is the 3-D powder printing technique (3D-P) developed at MIT; e.g., U.S. Pat. No. 5,204,055 (Apr. 1993 to Sachs, et al.), U.S. Pat. No. 5,340,656 (Aug. 23, 1994 to Sachs, et al.), U.S. Pat. No. 5,387,380 (Feb. 7, 1995 to Cima, et al.), and U.S. Pat. No. 6,007,318 (Dec. 28, 1999 to Russell, et al.). This 3-D powder printing technique involves dispensing a layer of loose powders onto a support platform and using an ink jet to spray a computer-defined pattern of liquid binder onto a layer of uniform-composition powder in a point-by-point fashion. The binder serves to bond together the powder particles on those areas (positive region) defined by this pattern. Those powder particles in the un-wanted areas (negative region) remain loose or separated from one another and are removed at the end of the build process. Another layer of powder is spread over the preceding one, and the process is repeated. The “green” part made up of those bonded powder particles is separated from the loose powders when the process is completed. This procedure is followed by binder removal and the impregnation of the green part with a liquid material such as epoxy resin and metal melt. Although several nozzle orifices may be employed to dispense several droplet streams at the same time, this 3D-P process remains to be essentially a point-by-point process, being characterized by a slow build speed.

This same drawback is true of the traditional selected laser sintering (SLS) technique (e.g., U.S. Pat. No. 4,863,538, Sep. 5, 1989 to C. Deckard; U.S. Pat. No. 4,938,816, Jul. 3, 1990 to J. Beaman, et al.; U.S. Pat. No. 4,944,817, Jul. 31, 1990 to D. Bourell, et al.; U.S. Pat. No. 5,155,324, Oct. 13, 1992 to C. Deckard, et al.; U.S. Pat. No. 5,156,697, Oct. 20, 1992 to D. Bourell; U.S. Pat. No. 5,316,580, May 31, 1994 to C. Deckard; U.S. Pat. No. 5,352,405, Oct. 4, 1994 to J. Beaman, et al.; U.S. Pat. No. 5,393,613, Feb. 28, 1995 to C. MacKay; U.S. Pat. No. 5,314,003, May 24, 1994 to MacKay; U.S. Pat. No. 5,431,967, Jul. 11, 1995 to A. Manthiram, et al; U.S. Pat. No. 5,732,323, Mar. 24, 1998, to 0. Nyrhila). The traditional SLS technique involves spreading a full-layer of loose powder particles and uses a computer-controlled, high-power laser to partially melt these particles within predetermined areas (positive region) in a point-by-point fashion. Commonly used powders include thermoplastic particles, thermoplastic-coated metal particles, metal-coated ceramic particles, and mixtures of high-melting and low-melting powder materials. These point-wise procedures are repeated for subsequent layers, one layer at a time, according to the CAD data of the sliced-part geometry. The loose powder particles in the negative region of each layer are allowed to stay as part of a support structure. The sintering process does not always fully melt the powder, but allows molten material to bridge between particles. Commercially available systems based on SLS are known to have several drawbacks. One problem is that the need to use a high power laser makes the SLS an expensive technique and un-suitable for use in an office environment. Again, the spot-by-spot or point-by-point laser scanning is a very slow procedure, resulting in a low object-building speed.

In U.S. Pat. No. 5,514,232, issued May 7, 1996, Burns discloses a method and apparatus for automatic fabrication of a 3-D object from individual layers of fabrication material having a predetermined configuration. Each layer of fabrication material is first deposited on a carrier substrate in a deposition station. The fabrication material along with the substrate are then transferred to a stacker station. At this stacker station the individual layers are stacked together, with successive layers being affixed to each other and the substrate being removed after affixation. One advantage of this method is that the deposition station may permit deposition of layers with variable colors or material compositions. In real practice, however, transferring a delicate, not fully consolidated layer from one station to another would tend to shift the layer position and distort the layer shape. The removal of individual layers from their substrate also tends to inflict changes in layer shape and position with respect to a previous layer, leading to inaccuracy in the resulting part.

Lamination-based layer manufacturing (LM) techniques that involve transferring thin sections of solid or powders, prepared by electro-photographic or electrostatic attraction, to a stacking station are disclosed in U.S. Pat. No. 5,088,047 (Feb. 11, 1992 to D. Bynum) and U.S. Pat. No. 5,593,531 (Jan. 14, 1997 to S. M. Penn). Lamination-based LM techniques that require radiation curing of solid sheet polymer materials layer by layer can be found in U.S. Pat. No. 5,174,843 (Dec. 29, 1992 to M. Natter) and U.S. Pat. No. 5,352,310 (Oct. 4, 1994 to M. Natter). Natter's technique is limited to high-energy radiation-curable polymer materials in a solid sheet form. Disclosed in U.S. Pat. No. 5,183,598 (Feb. 2, 1993 to J-L Helle, et al.) is a process that includes preparing thin sheets of a fiber- or screen-reinforced matrix material. In these composite sheets, the matrix material exhibits the feature that its solubility in a specific solvent can be changed when the material is exposed to a specific radiation. Selected areas of individual sheets are radiated to reduce the solubility. The un-irradiated portion (the negative region) of individual layers remains soluble in the solvent. The stack of sheets are affixed together to form an integral body, which is immersed in the solvent that causes the desired object to appear. This process exhibits the following shortcomings:

(1). A high-power radiation source (e.g., a laser beam) is required. High energy radiation sources and their handling equipment (for reflecting, focusing, etc) are expensive. Furthermore, they are not welcome in an office environment.

(2). When a screen is used as the reinforcement, the screen in the negative region is difficult to get dissolved in the solvent particularly if this screen is made of metal or ceramic materials. A strong acid is needed in dissolving a metal screen.

Due to the specific solidification mechanisms employed, many LM techniques are limited to producing parts from specific polymers. For instance, Stereo Lithography (SLa) and Solid Ground Curing (SGC) rely on ultraviolet (UV) light induced curing of photo-curable polymers such as acrylate and epoxy resins. The photo-curable polymer in these two cases constitutes the vast majority of the material in the resulting 3-D object. Any other ingredient such as an additive or reinforcement represents at best a minority phase in the structure. The photo-curable polymer in the resulting structure is “host” while any additive, if present, is just a guest. The host provides the basic structural integrity of the 3-D object.

In traditional SLa (e.g., according to U.S. Pat. No. 4,575,330, Mar. 11, 1986 to C. Hull), the polymer liquid is cured by a laser beam point by point in a layer. A much faster area-by-area curing of a photo-curable polymer liquid is disclosed in U.S. Pat. No. 5,094,935 Mar. 10, 1992 to Vassiliou, et al.). In SGC, each layer of a 3-D object is generated by a multi-step process. A thin layer of liquid polymer is prepared and then exposed to UV through a patterned mask having transparent areas corresponding to the cross section. UV radiation passing through the mask cures the exposed areas of the polymer. The remaining uncured polymer, while still a liquid, is then removed and replaced by wax. In the final step, both polymer and wax are machined to a uniform thickness, forming a smooth surface on which the next layer is built. Upon completion of the multi-layer process, the desired 3-D object is imbedded within a solid block of wax, which is then melted and removed. This is a very tedious process, demanding the operation of many pieces of heavy or expensive equipment. Again, the materials used are limited to photo-curable polymer liquids only. The SGC method is described in U.S. Pat. No. 5,031,120 (Jul. 9, 1991 to Pomerantz, et al.) And U.S. Pat. No. 5,287,435 (Feb. 15, 1994 to Cohen, et al.).

The above state-of-the-art review has indicated that all prior-art layer manufacturing techniques have serious drawbacks that prevent them from being more widely implemented.

Therefore, an object of the present invention is to provide an improved layer-additive method and apparatus that can be used for producing a 3-D object.

Another object of the present invention is to provide a computer-controlled method and apparatus for producing a part on a layer-by-layer, but not point-by-point basis (hence, with a high build speed).

It is a further object of this invention to provide a computer-controlled object building method that does not require heavy and expensive equipment such as a laser system.

It is another object of this invention to provide a method and apparatus for building a CAD-defined object in which the support structure is readily provided during the layer-adding procedure.

Still another object of this invention is to provide a layer manufacturing technique that places minimal constraint on the range of materials that can be used in the fabrication of a 3-D object.

### SUMMARY OF THE INVENTION

The Method

The objects of the invention are realized by a method and related apparatus for fabricating a three-dimensional object on a layer-by-layer basis (but not point-by-point) and in accordance with a computer-aided design (CAD) of this object. Basically, the method includes, in combination, the following steps:

(a) providing a work surface or support platform that lies substantially parallel to an X-Y plane of an X-Y-Z Cartesian coordinate system defined by three mutually perpendicular X-, Y- and Z-axes;

(b) feeding a first layer of a first powder to the work surface;

(c) spraying a predetermined quantity of a photo-curable liquid adhesive onto this first layer, allowing the adhesive to permeate through this layer and stay in gaps between powder particles for bridging between these particles;

(d) directing a programmable planar light source to predetermined areas (positive region) of the first layer corresponding to the first cross-section of the CAD design to at least partially cure the adhesive and bond the powder particles together in this region for the purpose of forming the first cross-section of this 3-D object;

(e) feeding a second layer of a second powder onto the first layer, spraying a predetermined quantity of a photo-curable liquid adhesive onto this second layer, and directing a programmable planar light source to predetermined areas (positive region) of this second layer corresponding to the second cross-section of the CAD design to at least partially cure the adhesive and bond the powder particles together in this region for the purpose of forming the second cross-section of the 3-D object;

(f) repeating the feeding, spraying, and directing steps to build successive layers along the Z-direction of the X-Y-Z coordinate system in a layer-wise fashion in accordance with the CAD design for forming multiple layers of the object; and

(g) removing powder particles along with the un-cured adhesive (in the negative region) to reveal this 3-D object.

The programmable planar light source is characterized by the following features:

(3) It provides a 2-D light source to cure the adhesive in selected areas of a powder layer; these areas being programmable and pre-determined by a computer. These areas (positive region) are defined by the layer data of a CAD design for the object to be built. A full area in a powder layer can be exposed to the light energy, as opposed to the case of operating a laser beam to sinter the powder spot by spot (essentially point by point) in a conventional selected laser sintering (SLS). This is also in sharp contrast to operating an inkjet printhead to print adhesive onto a layer of powder in a point-by-point fashion in a conventional 3D powder printing (3D-P or MIT) process.

(4) The adhesive in a positive region is sufficiently cured and hardened by this planar light source in such a manner that the adhesive flowing around to provide a bridge between particles can bond together these particles to impart sufficient strength and rigidity to the layer for easy handling and for maintaining the part dimensional accuracy during the formation of subsequent layers. Preferably, the light intensity and energy of the programmable planar light source is provided in such a fashion that successive layers can be affixed together to form a unitary body of the 3-D object.

(5) A complete powder layer can be pre-heated by other heat sources disposed near the object-building zone to a temperature (Tpre) sufficient for promoting the curing reaction once initiated by an incident light, but insufficient for initiating the curing reaction of the adhesive. This auxiliary heat would help accelerate the cure reaction and significantly reduce the light intensity requirement that would otherwise be imposed upon the planar light source. In this favorable situation, the planar light source can be just based on an ordinary ultraviolet (UV) light source. No expensive laser beam, electron beam, X-ray, Gamma-ray or other high-energy radiation is necessary.

(6) The physical sizes of this planar light source are preferably sufficient to cover the complete envelop of a powder layer so that a complete cross-section of the 3-D object can be built in one light exposure that lasts in seconds. This is in sharp contrast to the case of conventional selected laser sintering (SLS) which requires aiming a laser beam to one spot at a time (spot being micron- or sub-millimeter-sized). It would take a much longer time for a laser beam to scan a complete cross-section in a spot-by-spot or point-by-point fashion. Further, since adhesive spraying over a complete layer (not just the positive region) can be carried out in just a few seconds, this instant invention also has a significant advantage over the conventional 3D-P process, which involves ejecting adhesive droplets essentially point by point to cover the positive region only.

(7) If the physical sizes or coverage area of this planar light source are smaller than those of a powder layer, the planar light source may be permitted to travel on an X-Y plane. A few translational movements will let the planar light source completely cover the entire layer and allow a complete cross-section to be built.

In this method, the photo-curable adhesive may consist of such adhesive compositions as a base resin, a hardening or cross-linking agent, a photo-activator or photo-sensitizer, and possibly with additional catalyst and/or reaction accelerator. All of these compositions may be mixed together to form a complete adhesive mixture and be sprayed out at the same time onto a powder layer by an adhesive sprayer. Alternatively, one or more than one composition (preferably those compositions in a fine solid powder form) may be included as secondary ingredients in the powder to be dispensed one layer at a time by a powder feeder (powder-dispensing means).

The powder inside a powder feeder may comprise a primary body-building material (fine particles), additives (physical or chemical property modifiers), and secondary ingredients (compositions of an adhesive). In this method, the primary body-building powder may be composed of one or more than one type of fine particles. These fine powder particles could be of any geometric shape, but preferably spherical. The particle sizes are preferably smaller than 100 μm, further preferably smaller than 10 μm, and most preferably smaller than 1 μm. The size distribution is preferably uniform. There are three basic types of powders that can be used in the present invention:

Type A: fine particles of a primary body-building material only. In this type, only primary body-building materials in a fine particle form are included as the ingredients in the powder; no adhesive composition being included. All adhesive compositions are present as an adhesive liquid inside the adhesive sprayer and its storage container. The primary body-building materials can be selected from polymers, ceramics, glass, metals and alloys, carbon, and combinations thereof. The polymers may be thermoplastic (e.g., polyvinyl chloride) or thermosetting (e.g., epoxy oligomer powder). The adhesive, including all selected compositions, will be sprayed over a complete layer and allowed to permeate through the gaps in the powder. The adhesive in the positive region (corresponding to the desired cross-section) of a layer will be at least partially cured (chemically cross-linked or otherwise hardened) to bond together the primary body building particles. The adhesive in the negative region will not be exposed to the curing light and will remain in the liquid and soluble state.

Type B: fine ceramic, metallic, glass, or polymeric particles (as primary body-building materials) each coated with a thin layer of coating comprising selected adhesive compositions. Once a layer of these coated solid particles is deposited, the remaining compositions of an adhesive are then sprayed and allowed to permeate through the gaps between these particles. These other compositions are then in contact or reacted with the selected compositions in the coating to make a complete adhesive. The adhesive in the positive region of a layer is then at least partially cured by the planar light source means (to bond together body-building particles), leaving the adhesive in the negative region in an un-cured, soluble liquid state.

Type C: a mixture of fine particles of primary body-building materials (e.g., a silicon oxide powder) with at least one adhesive composition also in a fine powder form. The other remaining adhesive compositions are sprayed onto a layer of Type C powder mixture and allowed to flow around the fine particles and react with the at least one adhesive composition. The complete adhesive formulation in the positive region of this layer is then at least partially cured to provide inter-particle bonding for those primary body-building particles in the positive region. Again, the adhesive in the negative region will remain as a soluble material throughout the 3-D body-building process.

In each powder type, additional ingredients may be added to impart desired physical and/or chemical properties to the object being built. These ingredients may contain a reinforcement composition selected from the group consisting of short fiber, whisker, and particulate reinforcements such as a spherical particle, ellipsoidal particle, flake, small platelet, small disc, etc. These ingredients may also contain, but not limited to, colorants, anti-oxidants, anti-corrosion agent, sintering agent, plasticizers, etc.

Adhesive-spraying devices are commonplace. For instance, the coating- or paint-sprayer can be adapted for use in the present method. Several prior-art powder-dispensing means or feeders are available for feeding layers of powder materials, one layer at a time. The moving and dispensing operations of the adhesive-spraying means and powder-dispensing means and the operation of a programmable planar heat source are preferably conducted under the control of a computer. This can be accomplished by (1) first creating a geometry of the three-dimensional object on a computer with the geometry including a plurality of data points defining the object (a procedure equivalent to computer-aided design), (2) generating programmed signals corresponding to each of the data points, collected into layer-wise data sets, in a predetermined sequence; and (3) moving the adhesive-spraying and powder-dispensing means and the work surface relative to each other in response to these programmed signals. These signals may be prescribed in accordance with the G-codes and M-codes that are commonly used in computer numerical control (CNC) machinery industry.

In order to produce a multi-material 3-D object in which the material composition can vary from layer to layer, the presently invented method may further comprise the steps of (1) creating a geometry of the 3-D object on a computer with the geometry including a plurality of layer-wise sets of data points defining the object; each of the data sets being coded with a selected material composition, (2) generating programmed signals corresponding to each of the data sets in a predetermined sequence; and (3) operating the powder-dispensing means in response to the programmed signals to dispense and deposit powders of selected material compositions, with the material compositions varying possibly from layer to layer.

To further ensure the part accuracy and compensate for the potential variations in part dimensions (thickness, in particular), the present method may be executed under the assistance of dimension sensors. These sensors may be used to periodically measure the dimensions of the object being built while a computer is used to determine the thickness and outline of individual layers intermittently in accordance with a computer aided design representation of the object. The computing step includes operating the computer to calculate a first set of logical layers with specific thickness and outline for each layer and then periodically re-calculate another set of logical layers after periodically comparing the dimension data acquired by the sensor with the computer aided design representation in an adaptive manner.

The Apparatus

Another embodiment of this invention is a solid freeform fabrication apparatus for automated fabrication of a 3-D object. This apparatus includes:

(1) a work surface to support the object while being built;

(2) a powder-dispensing means at a predetermined initial distance from the work surface; the dispensing means having an outlet directed to the work surface for feeding successive layers of powder onto the work surface, one layer at a time, with the powder including at least a primary body-building material;

(3) an adhesive-spraying means at a predetermined initial distance from the work surface; the spraying means having an orifice directed to the work surface for feeding successive layers of adhesive onto the powder layers, one layer at a time;

(4) a programmable planar light source means at a predetermined initial distance from the work surface for providing curing energy to a predetermined region of a layer; and

(5) motion devices coupled to the work surface and the adhesive-spraying and powder-dispensing means for moving the/spraying/dispensing means and the work surface relative to each other in a plane defined by first and second directions (X- and Y-directions) and in a third direction (Z-direction) orthogonal to the X-Y plane to dispense multiple layers of powder and then adhesive, one layer at a time, for forming the 3-D object.

A programmable planar light source means may be selected from, but not limited to, the following four examples: (a) a liquid crystal display (LCD) plate as an erasable mask back-irradiated by an ultra violet (UV) source, (b) a matrix of light-emitting diodes (LEDs), (c) an ionographic image charging based erasable mask back-irradiated by an UV source, and (d) a silver halide film, or any other variable optical density photo-mask back-irradiated with a light source. The light source can be infrared (IR), visible, and/or ultra violet, with UV being preferred.

In order to automate the object-fabricating process, the present apparatus is preferably equipped with a computer-aided design computer and supporting software programs operative to (a) create a three-dimensional geometry of the 3-D object, (b) convert this geometry into a plurality of data points defining the object, and (c) generate programmed signals corresponding to each of the data points in a predetermined sequence. The apparatus also includes a three-dimensional motion controller electronically linked to the computer and the motion devices. The planar light source is also preferably electronically connected to the computer through a heat source controller. The motion controller is operated to actuate the motion devices and the light source controller is operated to activate the planar light source, both being responsive to the programmed signals for the data points received from the computer.

The apparatus preferably includes dimension sensors that are electronically linked to the computer. The sensors periodically provide layer dimension data to the computer. In the mean time, the supporting software programs in the computer act to perform adaptive layer slicing to periodically create a new set of layer data, including the data points defining the object, in accordance with the layer dimension data acquired by the sensors means. New sets of programmed signals corresponding to each of the new data points are generated in a predetermined sequence.

Specifically, the motion devices are responsive to a CAD-defined data file which is created to represent the 3-D preform shape to be built. A geometry (drawing) of the object is first created in a CAD computer. The geometry is then sectioned into a desired number of layers with each layer being comprised of a plurality of data points. These layer data are then converted to machine control languages that can be used to drive the operation of the motion devices as well as adhesive-spraying and powder-dispensing devices. These motion devices operate to provide relative translational motion of the adhesive-sprayer, powder-dispensing device and the planar light source with respect to the work surface in a horizontal direction within the X-Y plane. The motion devices further provide relative movements of the work surface relative to the planar light source, the adhesive-sprayer, and/or powder-dispensing device vertically in the Z-direction, each time by a predetermined thickness.

Advantages of the Invention

The process and apparatus of this invention have several features, no single one of which is solely responsible for its desirable attributes. Without limiting the scope of this invention as expressed by the claims which follow, its more prominent features will now be discussed briefly. After considering this brief discussion, and particularly after reading the section entitled “DESCRIPTION OF THE PREFERRED EMBODIMENTS” one will understand how the features of this invention offer its advantages, which include:

(1) The present invention provides a unique and novel method for producing a three-dimensional object on a layer-by-layer basis under the control of a computer. This method does not require the utilization of a pre-shaped mold or tooling.

(2) Most of the layer manufacturing methods, including powder-based techniques such as 3-D printing (3DP) and conventional selective laser sintering (SLS), are normally limited to the fabrication of an object in a point-by-point fashion and, hence, are very slow. In contrast, the presently invented method allows the fabrication of a part one complete layer at a time due to the full-field sized programmable planar light source being capable of precisely cure the adhesive in the positive region of a layer in one exposure. Therefore, the presently invented method can be order-of-magnitude faster than the conventional SLS and 3DP.

(3) The presently invented method provides a computer-controlled process which places minimal constraint on the variety of materials that can be processed. In the present method, the powder materials may be selected from a broad array of materials including various organic (including polymers) and inorganic substances (including ceramic, metal, glass, and carbon based materials) and their mixtures. This is in sharp contrast to both Stereo Lithography (SLa) and Solid Ground Curing (SGC), which solely rely on ultraviolet (UV) light-curable polymers such as acrylate and epoxy resins. The photo-curable polymer in both SGC and SLa represents the vast majority of the material in the resulting 3-D structure and is the “matrix” or “host” that accommodates any additive or reinforcement that might exist in the structure. The host basically provides the structural integrity of the 3-D object. The cured resin will not be removed or otherwise disintegrated. In the instant invention, the adhesive provides only a vehicle for tentatively holding together other otherwise loose powder particles. This cured adhesive constitutes only a minority material phase of the resulting 3-D structure. In the cases of ceramic, glass, or metal powder particles, this cured adhesive will be burned off leading to the formation of a somewhat porous structure. This porous structure is then either sintered at a high temperature to produce a solid body or impregnated with another liquid material (e.g., metal melt) to form a composite or hybrid material object. This final structure will contain no low-temperature material such as the polymeric adhesive (only metal and/or ceramic, e.g.). Both metal and ceramic materials can be used in a much higher temperature environment.

(4) The present method provides an adaptive layer-slicing approach and a thickness sensor to allow for in-process correction of any layer thickness variation. The present invention, therefore, offers a preferred method of layer manufacturing when part accuracy is a desirable feature.

(5) The method can be embodied using simple and inexpensive mechanisms, so that the fabricator apparatus can be relatively small, light, inexpensive and easy to maintain. No laser beam is required. A laser beam source is expensive and generally not safe to operate in an office environment.

(6) In the present method, a support structure naturally exists when a layer of powder is fed. No additional tool is needed to build support structure. This is in contrast to most of the prior-art layer-additive techniques that require a separate tool to build a support structure also layer by layer, thereby slowing down the part-building process.

### BRIEF DESCRIPTION OF THE DRAWINGS

FIG. 1 Schematic of an apparatus for building a 3-D object on a layer-by-layer basis, comprising a powder-dispensing device, an adhesive-spraying device, an object-supporting work surface capable of moving in an X-Y plane and in an orthogonal Z-axis in a desired sequence, a CAD computer, a control system, and a programmable planar light source.

FIG. 2 (a) Same as in FIG. 1, but with the planar light source being switched off and/or retrieved to a stand-by position upon completion of a second layer and (b) an adhesive sprayer with an applicator that comprises a plurality of orifices 29 through which a liquid adhesive can be sprayed.

FIG. 3 Schematic of three examples of programmable planar light sources: (a) a liquid crystal display (LCD) plate as an erasable mask back-irradiated by a light source such as an ultra violet (UV) source, (b) a matrix of light-emitting diodes (LEDs), and (c) an ionographic image charging-based photo-mask back-irradiated with an UV source.

FIG. 4 Three basic types of fine powder materials that can be used in the present invention: (a) fine particles of a primary body-building material, (b) primary body-building material particles coated with a thin coating comprising selected adhesive composition(s), and (c) a mixture of primary body-building material particles with at least one adhesive composition also in a fine powder form.

FIG. 5 (a) Schematic of a circuit diagram for a “cell” (comprising a LED element) and (b) a matrix of cells that work as a LED dot matrix (if “R” in FIG. 5(b) is a LED, as in FIG. 3(b)).

FIG. 6 Flow chart indicating a preferred process that involves using a computer and required software programs for adaptively slicing the geometry of an object into layer data and for controlling various components of the 3-D object building apparatus.

### DESCRIPTION OF THE PREFERRED EMBODIMENTS

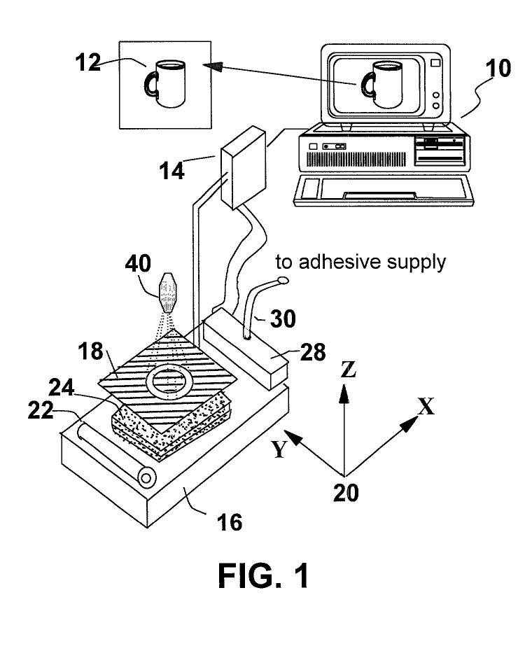

In the drawings, like parts have been endowed with the same numerical references. FIG. 1 illustrates one preferred embodiment of the presently invented apparatus for making a three-dimensional object. This apparatus is equipped with a computer 10 for creating a drawing or geometry 12 of an object (shown as a coffee cup) and, through a hardware controller 14 (including signal generator, amplifier, and other needed functional parts) for controlling the operation of other components of the apparatus. These other components include a powder-dispensing means 22, an adhesive sprayer 28 (supplied with adhesive compositions through a hose 30), a programmable planar light source means 18 (including a photo-mask back-irradiated with an UV source 40, as an example), and an object-supporting platform or work surface 16. The hardware controller 14 may comprise a planar light source controller, adhesive sprayer controller, powder-dispensing controller, and a motion controller.

Optional temperature-regulating means (e.g., heaters and temperature controllers, not shown) and pump means (not shown) may be used to provide a protective atmosphere and a constant temperature over a zone surrounding the work surface where a part 24 is being built. The heaters may be used to pre-heat the powder along with the adhesive prior to being exposed to the radiation from the planar light source means 18. A motion device (not shown) is used to position the work surface 16 with respect to the powder-dispensing device 22, the adhesive sprayer 30, and the planar light source means 18. After a layer of powder is deposited and a cross-section of the 3-D object is built, the powder feeder 22 and the work surface 16 are to be shifted away from each other by a predetermined distance to get ready for dispensing a next layer of powder. Preferably, the position of the adhesive-spraying device will also be adjusted relative to the work surface to ensure the consistency and uniformity in adhesive spraying.

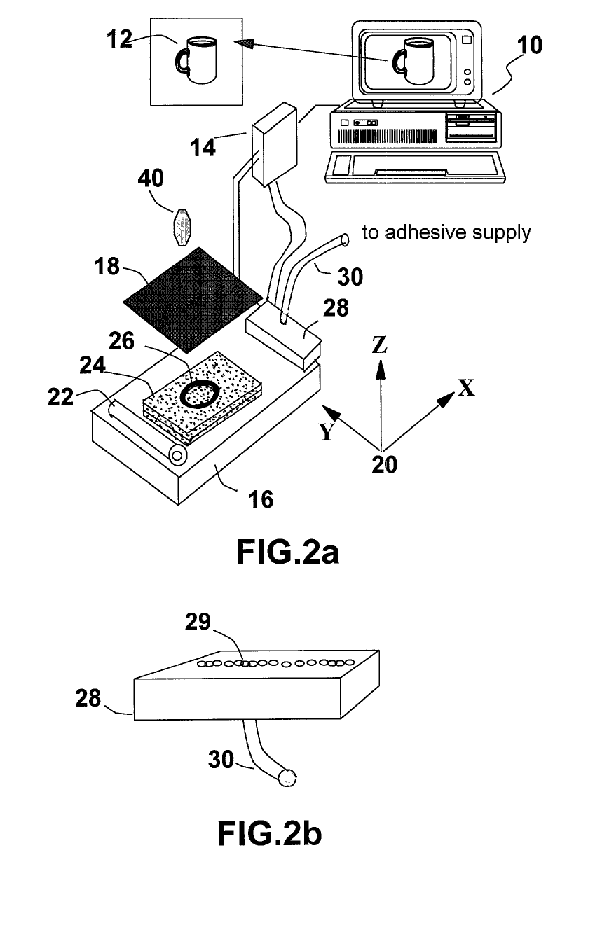

In one preferred embodiment of the present invention, the planar light source means 18 is capable of moving vertically along the Z-direction as defined by the rectangular coordinate system 20 shown in FIG. 1. When the planar light source means 18 is switched on or at a lower position, as indicated in FIG. 1, it provides a planar pattern of light to at least partially cure the adhesive that bonds powder particles within predetermined areas (referred to as the “positive region”) of a layer corresponding to a cross-section of the 3-D object being built. The adhesive in other areas (the negative region) of the same layer will not be exposed to the light from the planar light source means 18. Therefore, the powder particles in the negative region will not be “bonded” by the adhesive; they are simply wetted by or mixed with uncured, soluble liquid adhesive that can be later removed by simply dissolving it in a proper solvent. Once a layer is built (with the powder particles in the desired cross-section 26 being bonded or “sintered”), the planar light source is switched off and preferably also raised to a higher, stand-by position as indicated in FIG. 2.

Programable Planar Light Source Means

The programmable planar light source used in the present invention includes an essentially 2-D or plate-like device that is capable of providing curing light to selected areas of a powder-adhesive layer. These areas are programmable and pre-determined by a computer. These areas (the positive region) are defined by the layer data of a CAD design for the object to be built. The light provided by this planar light source means should ideally have no or little effect on the negative region of a powder layer. In other words, the adhesive in the negative region of a layer will not be exposed to the light coming from the planar light source when switched on. In this situation, the powder particles in the positive region, already wetted by or mixed with the adhesive, will be bonded by the adhesive when cured or hardened by the light source. When a cross-section of powder particles are substantially bonded together by the adhesive, a layer is said to be formed with the particles in the negative region being allowed to stay as part of a support structure.. Preferably, the adhesive is allowed to fully permeate through a current layer and the light intensity of the programmable planar light source is provided in such a fashion that this current layer is well-bonded to a previous layer and successive layers can be affixed together to form a unitary body of the 3-D object.

The programmable planar light source can be selected from, but not limited to, the following three examples:

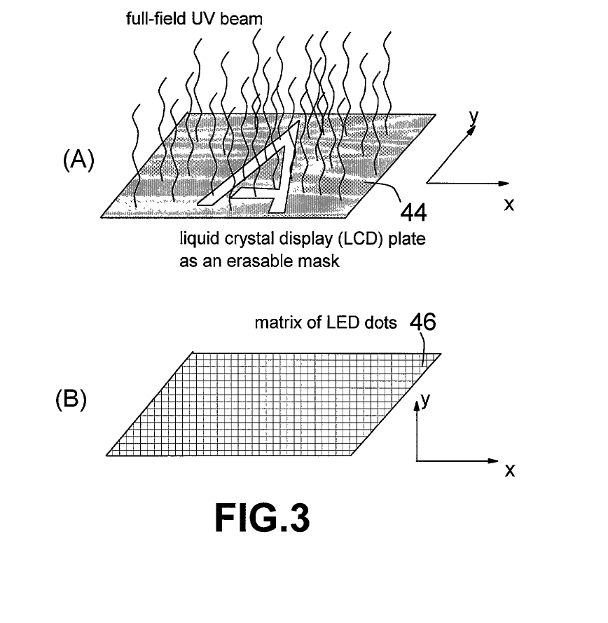

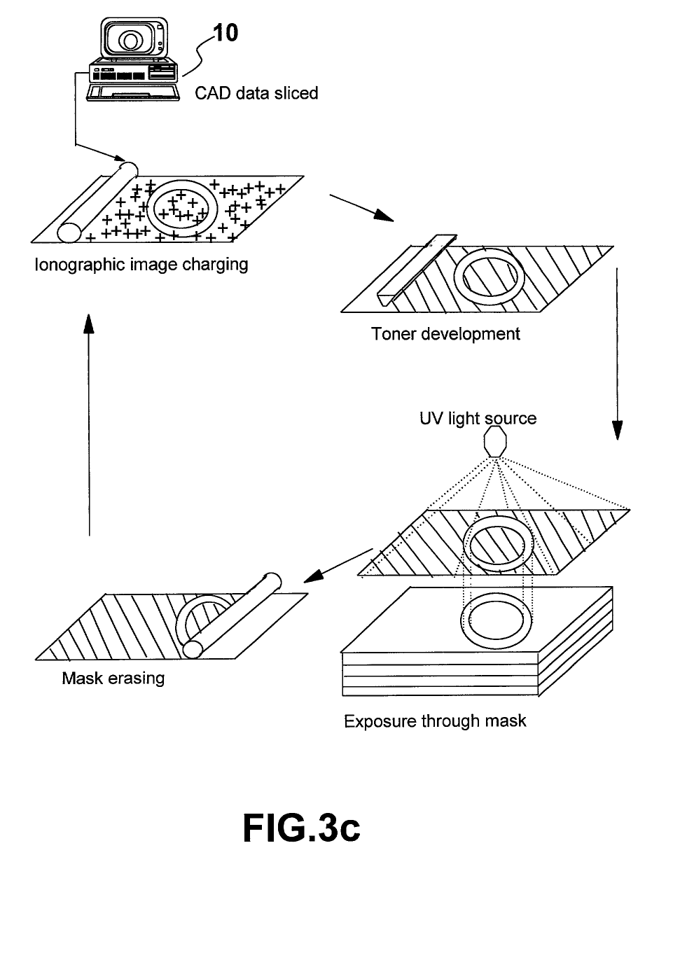

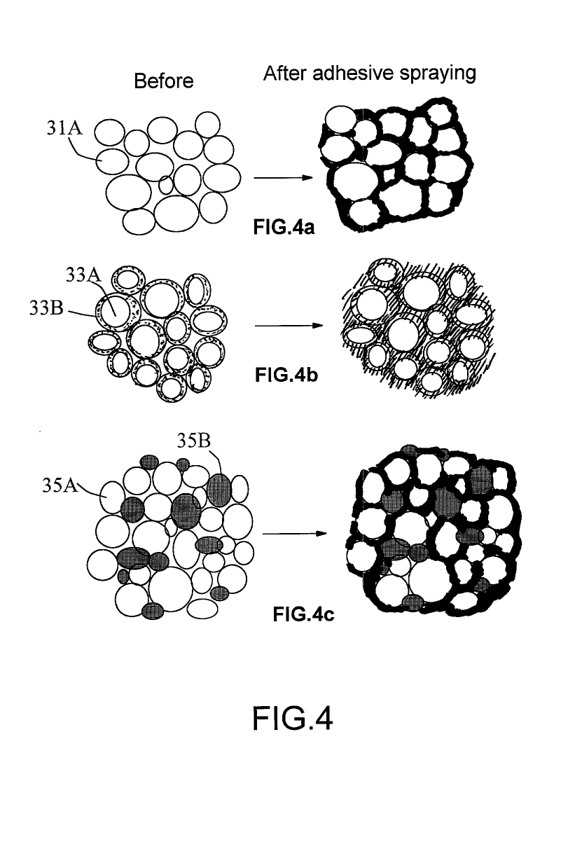

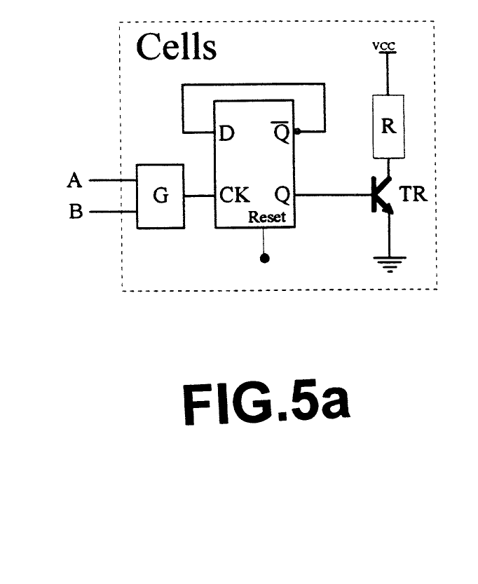

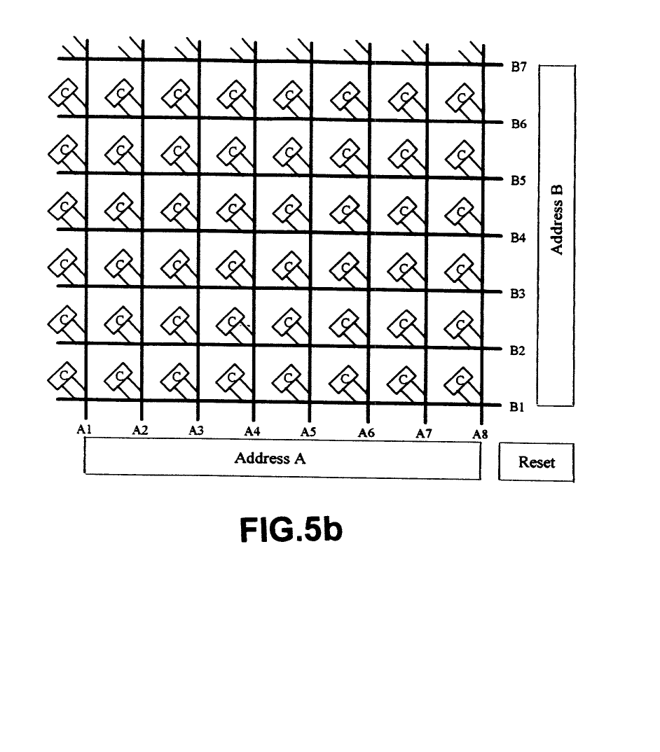

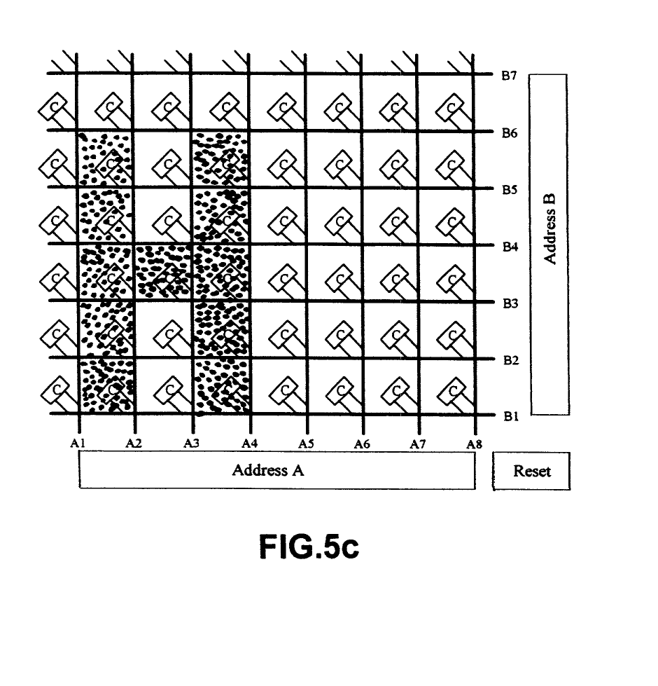

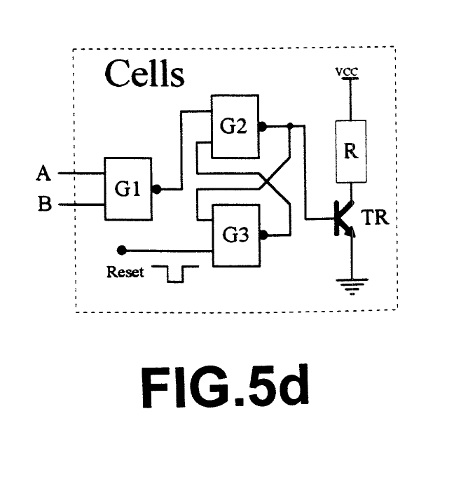

(1) A light-emitting diode (LED) dot matrix light source: a matrix of minute LED “dots” of a substantially uniform size preferably on the level of smaller than 100 μm, further preferably smaller than 10 μm, and most preferably smaller than 1 μm. FIG. 3(a) schematically shows such a “LED dot matrix” planar light source 42. Each dot can be represented by a cell, schematically shown in FIG. 5(a). An example of a cell circuit diagram, given in FIG. 5(a), comprises two input addresses A and B which send binary bit signals “0” or “1” through an “AND” gate G into a CK terminal of a D-trigger. The output of D is Q, which is connected to a transistor TR for driving a load R (a minute effector element, LED). The gate G, load R, two output points Q and \overline{O}, the clock CK, and the transistor TR together constitute the essential elements of a cell. In a LED dot matrix, R is a LED that provides a light with a predetermined wavelength range (e.g., IR, visible light, and/or UV light) over a small area, approximately of the cell size. In this circuit, \overline{O} is non-Q or opposite to Q with \overline{O}=“0” when Q=“1” and \overline{O}=“1” when Q=“0”. Before the start of a curing operation, A and B are in the unselected status (at “0” level), while Q remains at the “0” level (R being “OFF”) after a “RESET” signal is effected (a short “1” level, then “0”). Logically, the output Q will be “1” (and, hence, R is switched on) once both the input addresses A and B are “1”. The “1” status of the output Q will stay unchanged with R being always in “ON” status even though either or both of A and B becomes “0”. When both A and B of the same cell become “1” again or a new RESET signal comes, the output Q will be changed to “0” again with R being switched off. A large number of such cells or LED dots can be arranged in a square array as indicated in FIG. 5(b) by using a micro-electronic fabrication technique such as lithography. As further illustrated in FIG. 5(c), a planar light source in the shape of a capital letter H will be effected when the following pairs of input addresses are in “ON” or “1” status, in the following sequence: (A2,B1), (A2,B2), (A2,B3), (A2,B4), (A2,B5), (A3,B3), (A4,B1), (A4,B2), (A4,B3), (A4,B4), and (A4,B5). When the corresponding cells are switched on, this planar light source can be brought to a proper position (e.g., close to the top of a powder layer), resulting in curing of the adhesive and bonding of the powder particles withing this positive region designated by the letter H. After an H-shaped cross-section is formed, the above cells can be switched off by sending in a new RESET signal or re-selecting the above addresses in that sequence. This implies that the coverage region of this planar light source is programmable, in accordance with the CAD-defined cross-section data of a layer. With only one exposure for a short duration of time (normally in seconds), the at least partial curing of the adhesive can be accomplished.

FIG. 5(d) shows another example of the logic diagram of cells in a planar light source that can be conveniently operated. In this diagram, G1, G2, and G3 are the commonly used “NAND” gates in the field of logic circuit design. Herein, G1 is a selectable decoder while G2 and G3 serve as a R-S trigger. In the beginning, all the Rs in the planar light source are in the “OFF” status and the RESET terminal remains at the high or “1” level. When both input addresses are selected with “1” level, the functional element R will be activated and stay in the “ON” status until a new low level RESET signal comes again.

(2) A liquid crystal display-based erasable mask: a LCD plate is known to be capable of showing a programmable image. An image can be an UV-transparent region (e.g., the letter A in FIG. 3(a)) in an UV-opaque background. An UV source disposed above the LCD plate 44 will be transmitted through this selected area (positive region denoted by A) and helps to fat least partially cure the adhesive just underneath this A region when the LCD plate along with the UV source is brought to a desired height; e.g., just above (nearly touching) a current layer of powder for an image transfer at a 1:1 ratio. The image on the LCD can be readily erased and replaced with another image (just like in a notebook computer monitor). This new image again serves as a photo-mask to regulate the transmission of UV through a planar pattern of UV-transparent area in accordance with the CAD-defined cross-section of a layer.

(3) An ionographic image charging based erasable photo-mask back-irradiated by an UV source. As schematically shown in FIG. 3(c), a first image mask can be created according to a sliced layer data of a CAD design (a cross-section of a coffee cup being shown as an example) by first generating a pattern of charges and then developing a toner. The resulting photo-mask has a UV-transparent zone (a circular ring corresponding to the positive region) within a dark background that is opaque to the UV light. The UV light passing through this zone will at least partially cure the underlying adhesive, creating a cross-section of an object. The mask can then be erased for re-use. This planar light source is similar to that used in the SGC discussed earlier. It may be noted that any variable optical density film can be used as a photo-mask in the present method.

In each of the above three cases, a complete powder layer can be pre-heated by other heat sources disposed near the object-building zone to a temperature (Tpre) that is not sufficient to significantly initiate a cure reaction, but is sufficient to accelerate the cure reaction once initiated by the UV light. Chemical reaction rates are known to increase normally with increasing temperature, but temperature alone may not be sufficient to start out a chemical reaction. The pre-heating operation would significantly reduce the light intensity requirement or exposure time that would otherwise be imposed upon the planar light source. Curing of a layer does not necessarily have to be complete before attempting to build a subsequent layer. The cure reaction in a layer may be allowed to continue while other layers are being built, provided the curing is proceeded to an extent that the layer is sufficiently rigid and strong to support its own weight and the weight of subsequent layers.

The physical sizes of this planar light source are preferably sufficient to cover the complete envelop of a powder-adhesive layer so that there will be an one-to-one image mapping from the photo-mask pattern (or planar LED light source pattern) to the adhesive-curing pattern and a complete cross-section of the 3-D object can be built in one heat exposure that lasts in seconds. This is in sharp contrast to the case of conventional selected laser sintering (SLS) which requires aiming a laser beam to a spot at a time (spot being micron- or sub-millimeter-sized). It would take a much longer time for a laser beam to scan a complete cross-section in a spot-by-spot or point-by-point fashion. However, if the physical sizes of this planar light source are smaller than those of a powder layer, the source may be permitted to travel on an X-Y plane. A few translational movements will let the planar light source completely cover the entire layer and allow a complete cross-section to be built in a few exposures. One may also choose to adjust the ratio of the light source-mask separation over the mask-powder layer separation in such a fashion that a proportionally larger UV pattern (than the transparent zone on the mask plate) will impinge upon the powder-adhesive layer for forming a cross-section of the 3-D object.

Powder-Dispensing Devices (Powder Feeders)

A wide array of powder-dispensing devices may be used in the present freeform fabrication method and apparatus. Powder feeders are well-known in the art (e.g., for use in conventional SLS as described in U.S. Pat. No. 4,938,816, Jul. 3, 1990 to Beaman, et al and U.S. Pat. No. 5,316,580, May 31, 1994 to Deckard and for use in 3D powder printing as described in U.S. Pat. No. 5,204,055, Apr. 20, 1993 to Sachs, et al.). We have found it satisfactory to use a device (not shown) to provide a mound of powder with a predetermined volume at a time onto one end of the work surface and move a rotatable drum (22 in FIG. 2) from this end to another end with a desired spacing between the drum and the work surface. During such a translational motion, the drum also rotates in a direction counter to the translational motion direction, leaving a powder layer thickness being approximately equal to the desired spacing.

Adhesive-Spraying Devices

Adhesive-spraying devices are well-known in the art. Any coating or paint sprayer can be used to spray the liquid adhesive in the practice of the present invention. For instance, the spray guns supplied by Astro Packaging (Placentia, Calif., USA). We have found it satisfactory to use an air-pressurized spray gun with an applicator that comprises a plurality of orifices 29 (FIG. 2(b)) through which a liquid adhesive can be sprayed. The spray gun, with a linear array of orifices, while traversing from one end to another end (e.g., along the X-direction) of a deposited powder layer, will spray a desired quantity of liquid adhesive to cover the entire layer.

Adhesive and Powder Materials

In this method, the photo-curable adhesive may consist of such adhesive compositions as a base resin, a hardening or cross-linking agent, a photo-initiator, a photo-sensitizer, and possibly with a reaction accelerator. All of these compositions may be mixed together to form a complete adhesive mixture and be sprayed out at the same time onto a powder layer by an adhesive sprayer. Alternatively, one or more than one composition (preferably those compositions in a fine solid powder form) may be included as secondary ingredients in the powder to be dispensed one layer at a time by a powder feeder (powder-dispensing means).

The photo-curable adhesives which can be used in the practice of the present invention are any compositions which undergo solidification under exposure to an actinic radiation. Such compositions comprise usually but not necessarily a photo-sensitive material and a photo-initiator. The word “photo” is used here to denote not only light (preferably UV light), but also any other type of actinic radiation which may transform a liquid adhesive to a solid by exposure to such radiation. A wide variety of photo-curable adhesive resin compositions are available in the art. Examples of this transformation behavior include cationic polymerization, anionic polymerization, step-growth polymerization, free radical polymerization, and combinations thereof. Cationic polymerization is preferable and free radical polymerization is further preferable. One or more monomers may be utilized in the compositions. Monomers may be mono-functional, di-functional, tri-functional or multi-functional acrylates, methacrylates, vinyl, allyl, and the like. The adhesive compositions may comprise other functional and/or photo-sensitive groups such as epoxy, vinyl, isocyanate, urethane, and the like.

A large number of examples of photo-curable adhesive compositions can be found in both open literature and patents. For instance, the following U.S. patents provide a good source of these adhesive compositions: U.S. Pat. No. 6,110,987 (Aug. 29, 2000 to Kamata, et al.), U.S. Pat. No. 6,025,112 (Feb. 15, 2000 to Tsuda), U.S. Pat. No. 5,981,616 (Nov. 9, 1999 to Yamamura, et al.), U.S. Pat. No. 5,721,289 (Feb. 24, 1998 to Karim, et al.), U.S. Pat. No. 5,437,964 (Aug. 1, 1995 to Lapin, et al.), U.S. Pat. No. 5,094,935 (Mar. 10, 1992 to Vassiliou, et al.), U.S. Pat. No. 4,162,162 (Jul. 24, 1979 to Dueber), and U.S. Pat. No. 3,380,831 (Apr. 30, 1968 to Cohen, et al.). Commercially available photo-curable polymers that can be successfully in the present method include DSM Somos® solid imaging/rapid prototyping materials (e.g., Somos® 2100, 3100, 6100, 7100, 7110, 7120, 8100, 8110, and 8120 series) supplied by DSM (New Castle, Del., USA), Dymax Multi-cure®, Light Weld® and Ultra Light Weld® series fast-curing adhesives supplied by Dymax Corp. (Torrington, Conn., USA), Solimer® resins from Cubital America (Troy, Mich., USA), and SLa resins (CibaTool® SR 5170, 5180, and 5190) supplied by Ciba Geigy Specialty Chemicals Corp. (Los Angeles, Calif., USA).

The powder inside a powder feeder may comprise a primary body-building material (fine particles), additives (physical or chemical property modifiers), and secondary ingredients (compositions of an adhesive). In this method, the primary body-building powder may be composed of one or more than one type of fine particles. These fine powder particles could be of any geometric shape, but preferably spherical. The particle sizes are preferably smaller than 100 μm, further preferably smaller than 10 μm, and most preferably smaller than 1 μm. The size distribution is preferably uniform. There are three basic types of powders that can be used in the present invention:

Type A: fine particles of a primary body-building material only. In this type, only primary body-building materials in a fine particle form are included as the ingredients in the powder; no adhesive composition being included. All adhesive compositions are present as an adhesive liquid inside the adhesive sprayer and its storage container. The primary body-building materials can be selected from polymers, ceramics, glass, metals and alloys, carbon, and combinations thereof. The polymers may be thermoplastic (e.g., polyvinyl chloride) or thermosetting (e.g., epoxy oligomer powder). The adhesive, including all selected compositions, will be sprayed over a complete layer and allowed to permeate through the gaps in the powder. The adhesive in the positive region (corresponding to the desired cross-section) of a layer will be at least partially cured (chemically cross-linked or otherwise hardened) to bond together the primary body building particles. The adhesive in the negative region will not be exposed to the curing light and will remain in the liquid and soluble state.

Type B: fine ceramic, metallic, glass, or polymeric particles (as primary body-building materials) each coated with a thin layer of coating comprising selected adhesive compositions. Once a layer of these coated solid particles is deposited, the remaining compositions of an adhesive are then sprayed and allowed to permeate through the gaps between these particles. These other compositions are then in contact or reacted with the selected compositions in the coating to make a complete adhesive. The adhesive in the positive region of a layer is then at least partially cured by the planar light source means (to bond together body-building particles), leaving the adhesive in the negative region in an un-cured, soluble liquid state.

Type C: a mixture of fine particles of primary body-building materials (e.g., a silicon oxide powder) with at least one adhesive composition also in a fine powder form. The other remaining adhesive compositions are sprayed onto a layer of Type C powder mixture and allowed to flow around the fine particles and react with the at least one adhesive composition. The complete adhesive formulation in the positive region of this layer is then at least partially cured to provide inter-particle bonding for those primary body-building particles in the positive region. Again, the adhesive in the negative region will remain as a soluble material throughout the 3-D body-building process.

The primary body-building material can be selected from a wide variety of materials (polymers, ceramics, glass, metals and alloys, carbons, etc) provided they can be made into a powder form. Most of solid materials can be made into fine particles by using, for instance, a high-energy planetary ball-milling method.

The fact that any material that is available in a powder form can be used in both the traditional selected laser sintering (SLS) and the presently invented full-area curing technique (FACT) makes both techniques highly versatile. In each powder type, additional ingredients may be added to impart desired physical and/or chemical properties to the object being built. These ingredients may contain a reinforcement composition selected from the group consisting of short fiber, whisker, and particulate reinforcements such as a spherical particle, ellipsoidal particle, flake, small platelet, small disc, etc. These ingredients may also contain, but not limited to, colorants, anti-oxidants, anti-corrosion agent, sintering agent, plasticizers, etc.

Object-Supporting Work Surface and Motion Devices

Referring again to FIG. 1, the work surface 16 is located in close, working proximity to the dispensing devices. This work surface preferably has a flat region sufficiently large to accommodate the first few layers of the deposited material. The work surface 16 and the powder-dispensing device 22 are equipped with mechanical drive means for moving the powder-dispensing device from one end of the work surface to another end and for displacing the work surface a predetermined incremental distance relative to the powder-dispensing device along the Z-direction. The work surface and the planar light source can also be moved relative to each other vertically along the Z-direction and preferably also moveable along the X- and Y-directions so that even a smaller-sized planar heat source can cover a full powder layer in just a few displacement movements. This can be accomplished, for instance, by allowing the powder-dispensing device to be driven by at least one linear motion device to translate along the X-direction (defined in the X-Y-Z coordinate system 20 of FIG. 1), which is powered by a corresponding stepper motor, and driven to rotate in a direction counter to the translational motion to deposit a layer of powder. Preferably the planar light source is driven by a stepper motor to move up and down in the Z-direction relative to the work surface. The adhesive spraying device is also equipped with a motion device and controller that drive the spraying device horizontally in the X-direction (preferably also in the Y-direction) to spray one layer of adhesive at a time. The sprayer is then moved away from the work surface by a selected distance along the Z-direction to get ready for the next layer. Preferably, it is the work surface that moves vertically in the Z-direction by this selected distance with respect to the sprayer (and relative to the powder-dispensing device also). Motor means are preferably high resolution reversible stepper motors, although other types of drive motors may be used, including linear motors, servomotors, synchronous motors, D.C. motors, and fluid motors. Mechanical drive means including linear motion devices, motors, and gantry type positioning stages are well known in the art. The drive means, motion devices, and planar heat source are preferably subject to automated control by a computer 10, possibly through a hardware control system (14 of FIG. 1)

These movements will make it possible for the powder feeder and adhesive sprayer to feed successive layers of powder and adhesive and for the planar light source to move up (to a stand-by position) and down (to nearly touching the current layer of powder for curing), thereby forming multiple layers of materials of predetermined cross-sections and thicknesses, which build up on one another sequentially.

Sensor means may be attached to proper spots of the work surface or the material dispensing devices to monitor the physical dimensions of the physical layers being deposited. The data obtained are fed back periodically to the computer for re-calculating new layer data. This option provides an opportunity to detect and rectify potential layer variations; such errors may otherwise cumulate during the build process, leading to some part inaccuracy. Many prior art dimension sensors may be selected for use in the present apparatus.

Mathematical Modeling and Creation of Logical Layers

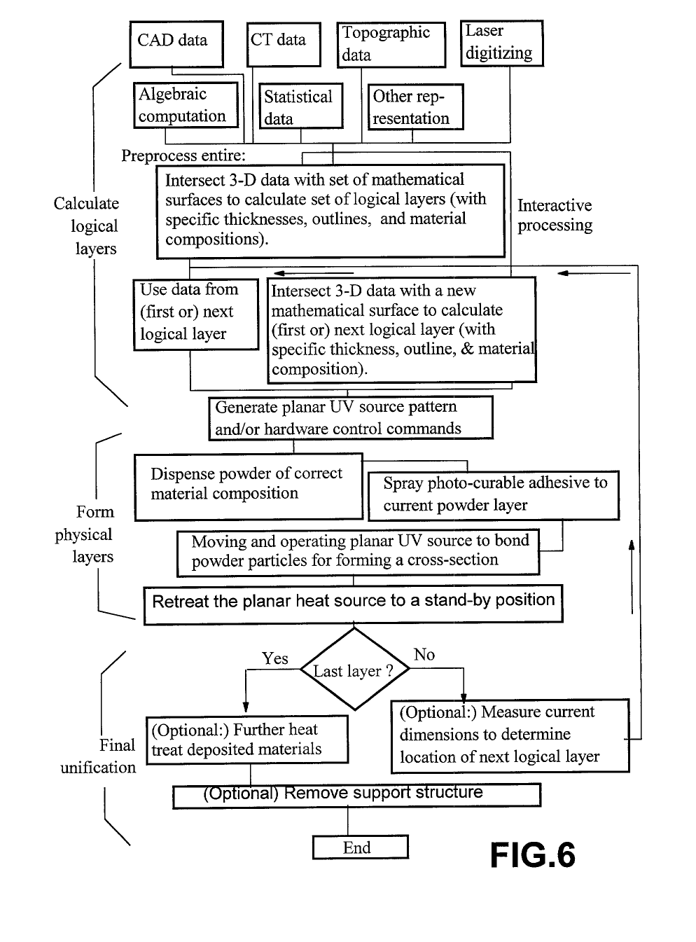

A preferred embodiment of the present invention is a solid freeform fabrication method in which the execution of various steps may be illustrated by the flow chart of FIG. 6. The method begins with the creation of a mathematical model (e.g., via computer-aided design, CAD), which is a data representation of a 3-D object. This model is stored as a set of numerical representations of layers which, together, represent the whole object. A series of data packages, each data package corresponding to the physical dimensions of an individual layer of deposited materials (powder and adhesive), is stored in the memory of a computer in a logical sequence so that the data packages correspond to individual layers of the materials are stacked together to form the object.

In one specific embodiment of the method, before the constituent layers of a 3-D object are formed, the geometry of this object is logically divided into a sequence of mutually adjacent theoretical layers, with each theoretical layer defined by a thickness and a set of closed, nonintersecting curves lying in a smooth two-dimensional (2-D) surface. These theoretical layers, which exist only as data packages in the memory of the computer, are referred to as “logical layers.” This set of curves forms the “contour” of a logical layer or “cross section”. In the simplest situations, each 2-D logical layer is a plane so that each layer is flat, and the thickness is the same throughout any particular layer.

As summarized in the top portion of FIG. 6, the data packages for the logical layers may be created by any of the following methods:

(1) For a 3-D computer-aided design (CAD) model, by logically “slicing” the data representing the model,

(2) For topographic data, by directly representing the contours of the terrain,

(3) For a geometrical model, by representing successive curves which solve “z=constant” for the desired geometry in an X-Y-Z rectangular coordinate system, and

(4) Other methods appropriate to data obtained by computer tomography (CT), magnetic resonance imaging (MRI), satellite reconnaissance, laser digitizing, line ranging, or other methods of obtaining a computerized representation of a 3-D object.

An alternative to calculating all of the logical layers in advance is to use sensor means to periodically measure the dimensions of the growing object as new layers are formed, and to use the acquired data to help in the determination of where each new logical layer of the object should be, and possibly what the thickness of each new layer should be. This approach, called “adaptive layer slicing”, could result in more accurate final dimensions of the fabricated object because the actual thickness of a sequence of stacked layers may be different from the simple sum of the intended thicknesses of the individual layers.

The closed, nonintersecting curves that are part of the representation of each layer unambiguously divide a smooth two-dimensional surface into two distinct regions. In the present context, a “region” does not mean a single, connected area. Each region may consist of several island-like subregions that do not touch each other. One of these regions is the intersection of the surface with the desired 3-D object, and is called the “positive region” of the layer. The other region is the portion of the surface that does not intersect the desired object, and is called the “negative region.” The curves are the boundary between the positive and negative regions, and are called the “outline” of the layer. In the present context, the programmable planar light source is allowed to cure the adhesive the adhesive in the “positive region” while little or no light from this planar light source will reach the “negative region” in each layer. The powder particles in the negative region remain loose and un-bonded (with the adhesive remaining a soluble liquid) and are allowed to stay as part of a support structure during the formation of a successive layer.

A preferred embodiment of the present invention contains a system that involves the use of a powder-dispensing devices, an adhesive-spraying device, an object-supporting platform or work surface, a programmable planar light source, and motion devices that are regulated by a computer-aided design (CAD) computer and a hardware controller. For example, as schematically shown in FIG. 1, the CAD computer with its supporting software programs operates to create a three-dimensional image of a desired object 12 or model and to convert the image into multiple elevation layer data, each layer being composed of a plurality of segments or data points.

As a specific example, the geometry of a three-dimensional object 12 may be converted into a proper format utilizing commercially available CAD/Solid Modeling software. A commonly used format is the stereo lithography file (.STL), which has become a de facto industry standard for rapid prototyping. The object image data may be sectioned into multiple layers by a commercially available software program. Each layer has its own shape and dimensions. These layers, each being composed of a plurality of segments or collection of data points, when combined together, will reproduce the complete shape of the intended object. In general, when a multi-material object is desired, these data points may be coded with proper material compositions. This can be accomplished by taking the following procedure:

When the stereo lithography (.STL) format is utilized, the geometry is represented by a large number of triangular facets that are connected to simulate the exterior and interior surfaces of the object. The triangles may be so chosen that each triangle covers one and only one material composition. In a conventional .STL file, each triangular facet is represented by three vertex points each having three coordinate points, (x₁,y₁,z₁), (x₂,y₂,z₂) and (x₃,y₃,z₃), and a unit normal vector (i,j,k). Each facet is now further endowed with a material composition code to specify the desired powder type. This geometry representation of the object is then sliced into a desired number of layers expressed in terms of any desired layer interface format (such as Common Layer Interface or CLI format). During the slicing step, neighboring data points with the same material composition code on the same layer may be sorted together. These segment data in individual layers are then converted into programmed signals. These signals include those data that are used for selecting a powder-dispensing device that feeds a specific powder type for a current layer in a proper format, such as the standard NC G-codes and M-codes commonly used in computerized numerical control (CNC) machinery industry. These layering data signals may be directed to a machine controller which selectively actuates the motors for moving the powder-dispensing device with respect to the object-supporting work surface, activates signal generators, drives the optional vacuum pump means, and operates optional temperature controllers, etc. The powder type can be readily varied from layer to layer. These signals also include those data that are used for forming the desired profile of a heating region provided by a programmable planar heat source. It should be noted that although .STL file format has been emphasized in this paragraph, many other file formats have been employed in different commercial rapid prototyping and manufacturing systems. These file formats may be used in the presently invented system and each of the constituent segments for the object geometry may be assigned a material composition code if an object of different material compositions at different portions is desired.

The hardware controller, preferably including a three-dimensional motion controller and a planar light source controller, are electronically linked to the mechanical drive means and the planar light source, respectively. The motion controller is operative to actuate the mechanical drive means in response to “X”, “Y”, “Z” axis drive signals for each layer received from the CAD computer. Controllers that are capable of driving linear motion devices are commonplace. Examples include those commonly used in a milling machine.

Numerous software programs have become available that are capable of performing the presently specified functions. Suppliers of CAD/Solid Modeling software packages for converting CAD drawings into .STL format include SDRC (Structural Dynamics Research Corp. 2000 Eastman Drive, Milford, Ohio 45150), Cimatron Technologies (3190 Harvester Road, Suite 200, Burlington, Ontario L7N 3N8, Canada), Parametric Technology Corp. (128 Technology Drive, Waltham, Mass. 02154), and Solid Works (150 Baker Ave. Ext., Concord, Mass. 01742). Optional software packages may be utilized to check and repair .STL files which are known to often have gaps, defects, etc. AUTOLISP can be used to convert AUTOCAD drawings into multiple layers of specific patterns and dimensions.

Several software packages specifically written for rapid prototyping have become commercially available. These include (1) SOLIDVIEW RP/MASTER software from Solid Concepts, Inc., Valencia, Calif.; (2) MAGICS RP software from Materialise, Inc., Belgium; and (3) RAPID PROTOTYPING MODULE (RPM) software from Imageware, Ann Arbor, Mich. These packages are capable of accepting, checking, repairing, displaying, and slicing .STL files for use in a solid freeform fabrication system. MAGICS RP is also capable of performing layer slicing and converting object data into directly useful formats such as Common Layer Interface (CLI). A CLI file normally comprises many “polylines” with each polyline being an ordered collection of numerous line segments.

A company named CGI (Capture Geometry Inside, currently located at 15161 Technology Drive, Minneapolis, Minn.) provides capabilities of digitizing complete geometry of a three-dimensional object. Digitized data may also be obtained from computed tomography (CT) and magnetic resonance imaging (MRI), etc. These digitizing techniques are known in the art. The digitized data may be re-constructed to form a 3-D model on the computer and then converted to .STL files. Available software packages for computer-aided machining include NC Polaris, Smartcam, Mastercam, and EUCLID MACHINIST from MATRA Datavision (1 Tech Drive, Andover, Mass. 01810).

Formation of the Physical Layers

The data packages are stored in the memory of a computer, which controls the operation of an automated fabricator comprising one or more than one powder feeder, at least an adhesive sprayer, a programable planar light source, a work surface, temperature controllers and pumps, and motion devices. Using these data packages, the computer controls the automated fabricator to select and feed a powder of the desired composition and to create a desired curing geometry (pattern) to form individual layers of materials in accordance with the specifications of an individual data package, one layer at a time. In one preferred embodiment of the invention, the adhesive has the property that it fully permeates through the gaps between the powder particles within the cross-section of a current layer. The adhesive, when being exposed to an actinic radiation from the planar light source, will be hardened to bond the powder particles together to form an integral layer. The adhesive compositions and the light intensity and frequency of the planar light source have the further property that the cross-section of a current layer will be bonded to a previous layer so that individual layers can be readily unified or consolidated.

Referring to FIG. 6, therefore, as another embodiment of the present invention, a solid freeform fabrication method for producing a 3-D object according to a CAD design of this object, may comprise the steps of:

(a) setting up a work surface that lies substantially parallel to an X-Y plane of an X-Y-Z Cartesian coordinate system;

(b) feeding a first layer of a first powder to the work surface and spraying the powder layer with a selected quantity of a photo-curable liquid adhesive;

(c) directing a programmable planar light source means to predetermined areas of the first layer corresponding to the first cross-section of the object to at least partially cure the adhesive compositions which serve to bond the powder particles together in these areas for the purpose of forming the first cross-section of the object;

(d) feeding a second layer of a second powder onto the first layer and spraying the second layer with a selected quantity of a photo-curable adhesive and directing a programmable planar light source means to predetermined areas of the second layer corresponding to the second cross-section of the object to at least partially cure the adhesive compositions which serve to bond together the powder particles in these areas for the purpose of forming the second cross-section of said 3-D object; (The powder in the second layer may be the same as or different from the powder in the first layer.) (e) repeating the feeding, spraying and directing steps to build successive layers along the Z-direction of the X-Y-Z coordinate system in a layer-wise fashion in accordance with the CAD design data for forming multiple layers of the object; and

(f) removing un-fused powder particles, causing the 3-D object to appear.

Preferably, a complete powder layer can be pre-heated by other heat sources disposed near the object-building zone to a temperature (Tpre) sufficient for promoting the curing reaction once initiated by an incident light, but insufficient for initiating the curing reaction of the adhesive. This auxiliary heat would help accelerate the cure reaction and significantly reduce the light intensity requirement that would otherwise be imposed upon the planar light source. In this favorable situation, the planar light source can be just based on an ordinary ultraviolet (UV) light source. No expensive laser beam, electron beam, X-ray, Gamma-ray or other high-energy radiation is necessary.

The operations of using a powder feeder and an adhesive sprayer and directing a programmable planar light source to bond the powder particles in predetermined areas of a layer preferably include the steps of (1) positioning the powder-dispensing and adhesive-spraying devices at a predetermined initial distance from the work surface; (2) operating and moving the dispensing/spraying devices relative to the work surface along selected directions in the X-Y plane to dispense and deposit a thin layer of the powder material and adhesive to the predetermined areas with a desired thickness; (3) switching on and moving the planar light source with a predetermined light coverage profile close to (but preferably not touching) the powder to cure the adhesive and bond the particles in the positive region; (4) retreating the planar light source to a stand-by position with the radiation being switched off; (5) moving the work surface away from the dispensing/spraying devices along the Z-axis direction by a predetermined layer distance to allow for the feeding and building of a subsequent layer. The movement of the dispensing/spraying devices relative to the work surface may be carried out by using any motor-driven linear motion devices, gantry table, or robotic arms which are all widely available commercially.

To facilitate automation of the apparatus used in the presently invented method, the moving and dispensing/spraying operations are preferably conducted under the control of a computer and harware controller. This can be accomplished by (1) first creating a geometry (CAD design) of the 3-D object on a computer with the geometry including a plurality of data points defining the object, (2) generating programmed signals corresponding to each of the data points in a predetermined sequence; and (3) moving the dispensing/spraying devices and the work surface relative to each other in response to these programmed signals. The motion control signals may be generated in standard formats, such as G-codes and M-codes that are commonly used in computer numerical control (CNC) machinery industry.

In order to produce a multi-material 3-D object in which the material composition varies from layer to layer, the presently invented method may further include the steps of (1) creating a geometry of the 3-D object on a computer with the geometry including a plurality of data points defining the object; each of the data points being coded with a selected material composition, (2) generating programmed signals corresponding to each of the data points in a predetermined sequence; and (3) operating the dispensing devices in response to the programmed signals to dispense and deposit selected powder material compositions.

It may be noted that, in some cases, the 3-D object formed according to the presently invented method may be composed of a high-melting material phase and a small amount of adhesive material phase. One may choose to burn off the adhesive, leaving behind some pores in the structure of the object. This porous object may then be impregnated with a solidifiable liquid material of a different type (e.g., a metal), allowing the new material to fill up the pores for forming a composite or hybrid material object.

What is claimed:

1. A method for fabricating a three-dimensional object in accordance with a computer-aided design of the object, said method comprising:
(a) providing a work surface lying substantially parallel to an X-Y plane of an X-Y-Z Cartesian coordinate system defined by three mutually perpendicular X-, Y- and Z-axes;
(b) feeding a first layer of a first powder to said work surface and spraying a predetermined quantity of a photo-curable liquid adhesive onto said first layer, allowing said adhesive to substantially permeate through said layer for bridging between powder particles;
(c) directing a programmable planar light source means to predetermined areas of said first layer corresponding to the first cross-section of said design to at least partially cure said adhesive and bond the powder particles together in said areas for the purpose of forming the first cross-section of said 3-D object;
(d) feeding a second layer of a second powder onto said first layer, spraying a predetermined quantity of said liquid adhesive onto said second layer, and directing a programmable planar light source means to predetermined areas of said second layer corresponding to the second cross-section of said design to at least partially cure said adhesive and bond the powder particles together in said areas for the purpose of forming the second cross-section of said 3-D object;
(e) repeating the feeding, spraying and directing steps to build successive layers along the Z-direction of said X-Y-Z coordinate system in a layer-wise fashion in accordance with said design for forming multiple layers of said object; and
(f) removing un-bonded powder particles and uncured adhesive, causing said 3-D object to appear.

2. A method for fabricating a three-dimensional object as set forth in claim 1, wherein at least one of said powder layers is pre-heated to a selected temperature to facilitate fast curing of said adhesive.

3. A method for fabricating a three-dimensional object as set forth in claim 2, wherein said programmable planar light source means provides ultra violet light.

4. A method for fabricating a three-dimensional object as set forth in claim 1, wherein said spraying and directing steps are carried out in such a manner that said successive layers are affixed together to form a unitary body of said 3-D object.

5. A method for fabricating a three-dimensional object as set forth in claim 1, wherein said programmable planar light source means is capable of providing light that covers the entire envelop of each of said successive layers of powder.

6. A method for fabricating a three-dimensional object as set forth in claim 1, wherein said programmable planar light source means is selected from the group consisting of a dot-matrix light-emitting diode-based source, an ionography based erasable mask back-irradiated with a light source, and a liquid crystal display-based erasable mask being back-irradiated by a light source, and combinations thereof.

7. A method for fabricating a three-dimensional object as set forth in claim 1, wherein said powder materials are selected from the group consisting of fine polymeric, glassy, metallic, ceramic, and carbonaceous particles, and combinations thereof.

8. A method for fabricating a three-dimensional object as set forth in claim 7, wherein said powder further comprises other ingredients for imparting desired physical or chemical properties to said 3-D object.

9. A method for fabricating a three-dimensional object as set forth in claim 1, comprising the further steps of:
providing a control means operably connected to said planar light source; and
supplying the control means with the boundaries of each cross-sectional region of said object.

10. A method for fabricating a three-dimensional object as set forth in claim 1, comprising the further steps of:
providing a control means having a computer; and
supplying the overall dimensions of the object to the computer, the computer determining the boundaries of each cross-sectional region of the object.

11. A method for fabricating a three-dimensional object as set forth in claim 1, wherein said feeding of powder layers is accomplished by using a dispensing means comprising a rotating drum.

12. A method for fabricating a three-dimensional object as set forth in claim 1, wherein the powder feeding step comprises the steps of:
positioning a powder-dispensing means at a predetermined initial distance from said work surface;
operating and moving said dispensing means relative to said work surface along selected directions in said X-Y plane to dispense and deposit a powder to form a layer on said work surface; and
after a cross-section of said object is built in said layer, moving said dispensing means away from said work surface along said Z-direction by a predetermined distance to allow for the feeding and building of a subsequent layer.

13. A method as defined in claim 1, further comprising the steps of:
creating a geometry of said three-dimensional object on a computer with said geometry including a plurality of data points defining the object;
generating programmed signals corresponding to each of said data points in a predetermined sequence; and
operating and moving said programmable planar light source means and said work surface relative to each other in response to said programmed signals.

14. A method as defined in claim 1, further comprising the steps of:
creating a geometry of said three-dimensional object on a computer with said geometry including a plurality of layer-wise data sets defining the object; each of said data sets being coded with a selected powder material composition;
generating programmed signals corresponding to each of said data sets in a predetermined sequence;
for each layer to be built, operating a powder-dispensing means to feed a current powder layer of said selected powder material composition onto said work surface or a previously fed layer and spraying a predetermined quantity of a photo-curable adhesive onto said current layer;
operating said programmable planar light source means in response to said programmed signals to cure the adhesive in said predetermined areas in a layer to bond and build a cross-section of said object in said layer; and
repeating said steps of operating a powder-dispensing means, operating an adhesive-spraying means, and operating said planar light source means to build a multi-material 3-D object.

15. A method as defined in claim 1, further comprising
using dimension sensor means to periodically measure dimensions of the object being built; and
using a computer to determine the thickness and outline of individual layers of powder materials in accordance with a computer aided design representation of said object; said computing step comprising operating said computer to calculate a first set of logical layers with specific thickness and outline for each layer and then periodically re-calculate another set of logical layers after periodically comparing the dimension data acquired by said sensor means with said computer aided design representation in an adaptive manner.

16. A method as defined in claim 1, further comprising operations of burning off said cured adhesive after step (f) thereby forming a 3-D porous body and impregnating said porous 3-D body with a solidifying liquid material to form a solid 3-D object.

17. A solid freeform fabrication apparatus for making a three-dimensional object from layers of solid powder and liquid adhesive, said apparatus comprising:
(b) a work surface to support said object while being built;
(c) a powder-dispensing means at a predetermined initial distance from said work surface, said dispensing means having an outlet directed to said work surface for feeding successive layers of powder onto said work surface one layer at a time;
(d) a moveable adhesive spraying means being disposed at a distance from said work surface for providing adhesive onto said successive layers of powder one layer at a time;
(e) a programmable planar light source means at a predetermined initial distance from said work surface for providing light to a predetermined region of a powder layer; and
(f) a light source controller electronically connected to said planar light source and motion devices coupled to said work surface, said powder-dispensing means, said planar light source, and/or said adhesive spraying means for moving said dispensing means, said spraying means, and/or said planar light source means relative to said work surface in a plane defined by first and second directions and in a third direction orthogonal to said plane to dispense, spray, and cure said multiple layers of powder and adhesive, one layer at a time, for forming said 3-D object.

18. Apparatus as set forth in claim 17, wherein said powder-dispensing means comprises a powder-feeding drum.

19. Apparatus as set forth in claim 17, further comprising:
a computer-aided design computer and supporting software programs operative to create a three-dimensional geometry of said 3-D object, to convert said geometry into a plurality of data points defining the object, and to generate programmed signals corresponding to each of said data points in a predetermined sequence;
said computer being electronically linked to said light source controller in control relation to said programmable planar light source;
a sprayer controller being electronically connected to said computer and in control relation to said adhesive-spraying means; and
a motion controller electronically linked to said computer and said motion devices; said motion controller being operative to actuate said motion devices and said light source controller being operative to activate said planar light source means in response to said programmed signals for said data points received from said computer.

20. Apparatus as set forth in claim 19, further comprising:
sensor means electronically linked to said computer and operative to periodically provide layer dimension data to said computer;
supporting software programs in said computer operative to perform adaptive layer slicing to periodically create a new set of layer data comprising data points defining the object in accordance with said layer dimension data acquired by said sensor means, and to generate programmed signals corresponding to each of said data points in a predetermined sequence.

21. Apparatus as set forth in claim 17, wherein said programmable planar light source means is selected from the group consisting of a dot-matrix light-emitting diode-based source, an ionography based erasable mask back-irradiated with a light source, and a liquid crystal display-based erasable mask being back-irradiated by a light source, and combinations thereof.

22. Apparatus as set forth in claim 17, wherein said powder-dispensing means and/or said work surface are provided with heating means for pre-heating the powder material.

23. Apparatus as set forth in claim 19, wherein said programmable planar light source is provided with at least a motion device electronically connected through a motion controller to said computer for moving said planar light source relative to said work surface.

24. Apparatus as set forth in claim 17, wherein said work surface is provided with a protective environment.

25. A method for making a three-dimensional object from layers of powder materials and photo-curable adhesive compositions, said method comprising the steps of:
positioning a work surface in proximity to, and at a predetermined initial distance from, means for storing and supplying a powder material;
depositing a layer of said powder material onto said work surface;
dispensing a predetermined amount of a photo-curable material onto said layer of powder material;
utilizing a programmable planar light source to provide actinic radiation energy into selected areas of said layer of powder and adhesive, one finite area at a time, to at least partially cure the adhesive sufficient for bonding powder particles together in said areas to form a cross-section of said object, the adhesive and powder particles in the negative region other than said selected areas of a layer remaining uncured and un-bonded;
repeating said depositing, dispensing and utilizing steps to form a plurality of layers, each of said layers being integrally bonded to the next adjacent of said layers by said utilizing steps to form an integral 3-D body imbedded in a matrix of uncured adhesive and un-bonded powder particles; and
removing said un-cured adhesive and said un-bonded powder particles in said negative region, causing said 3-D object to appear.

26. A method according to claim 25, wherein said layers of powder material are pre-heated to a pre-selected temperature.

27. A method according to claim 25, comprising the further steps of burning off the cured adhesive in said 3-D object forming a porous 3-D body and impregnating said porous body with a solidifying liquid to form a solid 3-D object.
